(19) United States
(12) Patent Application Publication
(10) Pub. No.: US 2013/0185527 A1
(43) Pub. Date: Jul. 18, 2013

(54) Asymmetrically-Arranged Memories having Reduced Current Leakage and/or Latency, and Related Systems and Methods

(71) Applicants: Joshua L. Puckett, Raleigh, NC (US); Gregory Christopher Burda, Raleigh, NC (US)

(72) Inventors: Joshua L. Puckett, Raleigh, NC (US); Gregory Christopher Burda, Raleigh, NC (US)

(73) Assignee: QUALCOMM INCORPORATED, San Diego, CA (US)

(21) Appl. No.: 13/420,779

(22) Filed: Mar. 15, 2012

Related U.S. Application Data
(60) Provisional application No. 61/586,867, filed on Jan. 16, 2012.

(51) Int. Cl. G06F 12/00

(52) U.S. Cl. 711/154; 711/E12.001

(57) ABSTRACT

Asymmetrically-arranged memories having reduced current leakage and/or latency, and related systems and methods are disclosed. In one embodiment, a memory comprises a memory access interface (MAI). The memory further comprises a first memory portion(s) accessible by the MAI. The first memory portion(s) has a first latency and a first current leakage. The memory further comprises a second memory portion(s) accessible by the MAI. To provide an asymmetrical memory arrangement, the first latency of the first memory portion(s) is increased such that the second memory portion(s) has a second latency greater than or equal to the first latency and a second current leakage greater than the first current leakage. Accordingly, the overall current leakage of the memory is reduced while not increasing overall latency of the memory. The first and second memory portion(s) may each be comprised of one or more memory sub-bank(s) and/or one or more memory bank(s).

### PRIORITY APPLICATION

The present application claims priority to U.S. Provisional Patent Application Ser. No. 61/586,867 entitled “ASYMMETRICALLY-ARRANGED MEMORIES HAVING REDUCED CURRENT LEAKAGE AND/OR LATENCY, AND RELATED SYSTEMS AND METHODS” filed on Jan. 16, 2012, which is hereby incorporated herein by reference in its entirety.

### BACKGROUND

I. Field of the Disclosure

The technology of the disclosure relates generally to computer memories, computer memory design, and related systems and methods for reducing memory power consumption and latency.

II. Background

In a processor-based memory architecture, it is generally desirable to have fast memory access times (i.e. low memory latency). The overall memory latency of a memory may be defined as the worst-case latency to access a memory location in the memory. The resistance of bit and word lines connected between a memory access interface (MAI) and memory cells in memory banks affect memory latency. As length of the bit and word lines increase, so does the resistance, and in turn so does the signal delay on the hit and word lines. Accordingly, memory banks located farther in distance from a memory access interface (MAI) will generally suffer greater resistance delay than memory banks located closer in distance to the memory access interface (MAI). Accordingly, the memory bank located farthest from the memory access interface (MAI) may determine the worst-case latency (i.e. worst case memory access time) of the memory.

In this regard, FIG. 1 illustrates an exemplary hierarchical memory 10. The memory 10 may be a static random access memory (SRAM) as an example. The memory 10 comprises a memory access interface (MAI) 12 and eight memory banks 14(0)-14(7). Each memory bank 14(0)-14(7) is located a given distance D(0)-D(7), respectively, from the memory access interface (MAI) 12. Memory bank 14(0) is located closest to the memory access interface (MAI) 12 at distance D(0), and memory bank 14(7) is located farthest from the memory access interface (MAI) 12 at distance D(7). Because memory bank 14(7) is located farthest from the memory access interface (MAI) 12, memory bank 14(7) experiences the longest bit and word line resistance delays. As a result, memory bank 14(7) provides the worst-case latency among all the memory banks 14(0)-14(7) in the memory 10 in this example. Memory banks 14(0)-14(6), being located closer to the memory access interface (MAI) 12 than memory bank 14(7), will experience less bit and word line resistance delays and lower latency than memory bank 14(7) as a result. Thus, while memory banks 14(0)-14(6) have latency margin as compared to memory bank 14(7), it is of no consequence, because memory bank 14(7) determines the overall latency of memory 10.

### SUMMARY OF THE DISCLOSURE

Embodiments disclosed in the detailed description include asymmetrically-arranged memories having reduced current leakage and/or latency, and related systems and methods. In this regard in one embodiment, a memory comprises a memory access interface (MAI). The memory further comprises a first memory portion(s) accessible by the MAI. The first memory portion(s) has a first latency and a first current leakage. The memory further comprises a second memory portion(s) accessible by the MAI. The first and second memory portion(s) may be comprised of a memory bank(s) and/or a memory sub-bank(s). To provide an asymmetrical memory arrangement, the first latency of the first memory portion(s) is increased such that the second memory portion(s) has a second latency greater than or equal to the first latency of the first memory portion(s). As a result, the first current leakage of the first memory portion is reduced such that the second memory portion(s) has a second current leakage greater than the first current leakage of the first memory portion(s). In this manner, the overall current leakage of the memory is reduced while not increasing the overall latency of the memory.

As non-limiting examples, the first memory portion(s) may be located a first distance from the MAI, and the second memory portion(s) may be located a second distance greater than the first distance from the MAI. The second latency may be less than the first latency by a first latency differential threshold. The second current leakage may be greater than the first current leakage by a first current leakage differential threshold. The channel length, channel width, and/or threshold voltage (Vt) of memory cell transistors in the first memory portion(s) may be altered to increase latency of the first memory portion(s) and to reduce current leakage in the first memory portion(s) while not increasing the latency of the second memory portion(s) and while also not increasing the overall latency of the memory. In this manner, the overall current leakage of the memory is reduced while the overall latency of the memory is not increased.

In another embodiment, a memory comprises a memory access interface (MAI) means. The memory further comprises a first memory portion(s) means accessible by the MAI means. The first memory portion(s) means has a first latency and a first current leakage. The memory further comprises a second memory portion(s) means accessible by the MAI means. The second memory portion(s) means has a second latency greater than or equal to the first latency and a second current leakage greater than the first current leakage.

In another embodiment, a memory system is provided. The memory system comprises a memory. The memory comprises a MAI. The memory further comprises a first memory portion(s) accessible by the MAI. The first memory portion(s) has a first latency and a first current leakage. The memory further comprises a second memory portion(s) accessible by the MAI. The second memory portion(s) has a second latency greater than or equal to the first latency and a second current leakage greater than the first current leakage. The memory system further comprises a memory controller configured to access the memory through access to the MAI.

In another embodiment, a method of designing a memory is provided. The method comprises providing a memory arrangement. The memory arrangement comprises a MAI. The memory arrangement further comprises symmetric memory banks having symmetric transistor characteristics. The method further comprises measuring latency of a closer memory bank(s) to the MAI. The method further comprises measuring latency of a farther memory bank(s) from the MAI. The method further comprises determining a memory bank latency margin of the closer memory bank(s). The method further comprises, in response to determining that the closer memory bank(s) has a positive memory bank latency margin, modifying transistor characteristics in a memory sub-bank(s) of the closer memory bank(s) to reduce current leakage of the closer memory bank(s).

In another embodiment, a non-transitory computer-readable medium having stored thereon computer-executable instructions is provided. The instructions cause the processor to provide a memory arrangement. The memory arrangement comprises a MAI and symmetric memory portions. The instructions further cause the processor to measure a first latency of a farther memory portion(s) from the MAI. The instructions further cause the processor to measure a second latency of a closer memory portion(s) to the MAI. The instructions further cause the processor to determine latency margin of the closer memory portion(s). The instructions further cause the processor, in response to determining the closer memory portion(s) has positive latency margin, to increase the latency in the closer memory portion(s) to reduce current leakage of the closer memory portion(s).

### BRIEF DESCRIPTION OF THE FIGURES

FIG. 1 is a block diagram of an exemplary memory having a memory access interface (MAI) and a plurality of hierarchical memory banks, each hierarchical memory bank located a given distance from the MAI;

FIG. 2 is a diagram of an exemplary memory system as part of an exemplary processor-based system comprising a memory controller and associated asymmetrically-arranged memory;

FIG. 3A is a diagram of an exemplary asymmetrically-arranged memory having a first memory portion and a second memory portion, the second memory portion having a second latency greater than or equal to a first latency of the first memory portion and a second current leakage greater than a first current leakage of the first memory portion;

FIG. 3B is a diagram of the asymmetrically-arranged memory of FIG. 3A, wherein the first memory portion is comprised of one or more memory sub-banks and/or one or more memory banks, and wherein the second memory portion is also comprised of one or more memory sub-banks and/or one or more memory banks;

FIG. 4 is a diagram of an exemplary asymmetrically-arranged memory having three or more asymmetrical memory portions;

FIG. 5 is a diagram of an exemplary asymmetrically-arranged memory having memory portions driven by a global bit line;

FIG. 6 is a flowchart illustrating an exemplary process for designing an asymmetrically-arranged memory to reduce current leakage by increasing latency in a closer memory portions(s) based on a determined latency margin among the closer and farther memory portions(s);

FIG. 7 is a flowchart illustrating a further exemplary process for designing an asymmetrically-arranged memory to reduce current leakage by increasing latency in a farther memory portion(s) based on a determined latency margin among the farther memory portion(s) and overall latency of the memory, the latency margin of the farther memory portion(s) resulting from the overall load of the memory being reduced by increasing the latency in the closer memory portion(s) to reduce current leakage in the closer memory portion(s) according to the method of FIG. 6; and

FIG. 8 is a block diagram of an exemplary processor-based system that includes an asymmetrically-arranged memory.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description include asymmetrically-arranged memories having reduced current leakage and/or latency, and related systems and methods. In this regard in one embodiment, a memory comprises a memory access interface (MAI). The memory further comprises a first memory portion(s) accessible by the MAI. The first memory portion(s) has a first latency and a first current leakage. The memory further comprises a second memory portion(s) accessible by the MAI. The first and second memory portion(s) may be comprised of a memory bank(s) or a memory sub-bank(s). To provide an asymmetrical memory arrangement, the first latency of the first memory portion(s) is increased such that the second memory portion(s) has a second latency greater than or equal to the first latency of the first memory portion(s). As a result, the first current leakage of the first memory portion is reduced such that the second memory portion(s) has a second current leakage greater than the first current leakage of the first memory portion(s). In this manner, the overall current leakage of the memory is reduced while not increasing the overall latency of the memory.

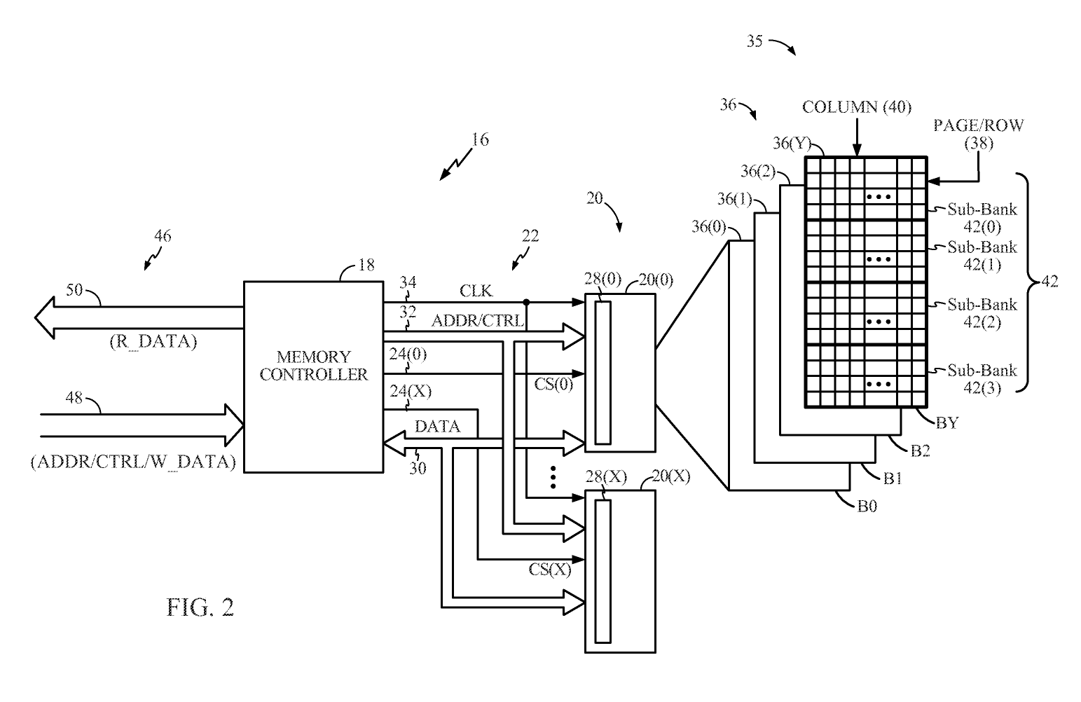

In this regard, FIG. 2 illustrates an exemplary memory system 16 having asymmetrically-arranged memory to reduce current leakage while not increasing overall latency of the memory. Before discussing exemplary asymmetrically-arranged memories, the memory system 16 in FIG. 2 is first discussed. In this regard, the memory system 16 includes a memory controller 18. The memory controller 18 is configured to provide access to a memory 20 in the memory system 16. The memory controller 18 is responsible for the flow of data going to and from the memory 20. In the illustrated example, the memory controller 18 is responsible for controlling the flow of data to and from two or more memory chips 20(0)-20(X). The memory controller 18 may be any type of memory controller compatible with its memory chips 20(0)-20(X). Further, the memory controller 18 as illustrated may be provided on a motherboard or other printed circuit board (PCB) as a separate device, or integrated on at least one CPU or semiconductor die.

With continuing reference to FIG. 2, as a non-limiting example, the memory chips 20(0)-20(X) may be static random access memory (SRAM) memory chips. In this regard, the memory controller 18 may be a SRAM memory controller. As a further non-limiting example, each memory chip 20(0)-20(X) may be a dynamic random access memory (DRAM) chip. In this regard, the memory controller 18 may be a DDR memory controller. However, the memory chips 20(0), 20(X) may be any kind of dynamic memory. Non-limiting examples include RAM, DRAM, SDRAM, DDR, DDR2, DDR3, MDDR (Mobile DDR), LPDDR, LPDDR2, ROM, PROM, EEPROM, flash memory, SRAM, 6T SRAM, 8T SRAM, and/or 10T SRAM, 1T SRAM, 2T SRAM, zero capacitor RAM (Z-RAM). Similar apparatuses and methods may also be provided using magnetoresistive RAM (MRAM) (which stores data in magnetic storage elements) and phase-change memory (PRAM or PCM) (which stores data based on phase change properties of chalcogenide glass using heat).

The memory controller 18 controls the flow of data to and from a memory access interface (MAI) 28(0), 28(X) in the memory chips 20(0)-20(X) via a memory bus 22. In this example, the memory bus 22 includes chip selects (CS(0)-CS(X)) 24(0)-24(X) for each memory chip 20(0)-20(X). The chips selects 24(0)-24(X) are selectively enabled by the memory controller 18 to enable the memory chips 20(0)-20(X) containing the desired memory location to be accessed. The memory bus 22 also includes an address/control bus (ADDR/CTRL) 32 that allows the memory controller 18 to control the memory address accessed through the memory access interfaces (MAIs) 28(0)-28(X) in the memory chips 20(0)-20(X) for either writing or reading data to or from the memory 20. The memory bus 22 also includes a clock signal (CLK) 34 to synchronize timing between the memory controller 18 and the memory chips 20(0)-20(X) for memory accesses.

With continuing reference to FIG. 2, each memory chip 20(0), 20(X) includes a memory access interface (MAI) 28(0), 28(X), referred to generally as element 28. A memory access interface (MAI) 28 receives address and control signals asserted by memory controller 18 over address/control bus 32. In this regard, when the memory controller 18 instructs the memory access interface (MAI) 28(0) to read data from a memory bank 36 on the memory chip 20(0), the memory access interface (MAI) 28(0) places the requested data on the data bus 30. When the memory controller 18 instructs the memory access interface (MAI) 28(0) to write certain data to a memory bank 36 on the memory chip 20(0), the memory access interface (MAI) 28(0) writes the certain data from the data bus 30 to a memory bank 36 on the memory chip 20(0) according to the address specified on an address/control bus 32 by memory controller 18. Though operations described above refer to an exemplary memory chip 20(0), each memory chip 20 includes a memory access interface (AT) 28 which provides similar operations for accessing memory banks 36 of that memory chip 20, in this regard, the memory access interface (MAI) 28 is provided on the same memory chip 20 as the memory banks 36 for which it provides an interface.

Each memory chip 20(0)-20(X) in this example contains a plurality of memory portions 35. In one embodiment, the memory portions 35 are each memory banks, referred to generally as element 36. A memory bank is a logical unit of memory, in the illustrated example, each memory chip 20(0)-20(X) contains a plurality of memory banks 36(0)-36(Y) (also denoted B0-BY). Each memory bank 36 is organized into a grid-like pattern, with “rows” or memory pages 38 and “columns” 36. The accessed data may be provided by the memory controller 18 over a system bus 46 to another component in a processor-based system. In the illustrated example of FIG. 2, the system bus 46 comprises an address/control/write data (ADDR/CTRL/W_DATA) bus 48 that receives the address of the memory location to be accessed as well as any data to be written to the memory 20. A read data (R_DATA) bus 50 is also provided to carry data read from the memory 20. The memory controller 18 asserts data from a read memory location in the memory 20 onto the R_DATA bus 50.

A memory bank 36 may comprise one or more memory “sub-banks” referred to as memory sub-bank(s) 42. A memory sub-bank 42 is comprised of one or more memory pages 38 in a memory bank 36. The memory portions 35 may comprise one or more of the memory sub-bank(s) 36. When a memory bank 36 is comprised of multiple memory sub-banks 42, each memory sub-bank 42 may comprise a same or different number of memory pages 38 than other memory sub-banks 42 of the memory bank 36.

It may be important to conserve power in the memory system 16 in FIG. 2. Total power consumption of the memory system 16 comprises power consumption when memory 20 is being accessed and power consumption when the memory system 16 is in standby mode and not being accessed. When the memory system 16 is in standby, the memory portions within the memory 20 may experience current leakage. However, the disclosure herein recognizes that if the memory portion(s) in the memory 20 closer to the MAI 28 has lower latency than a memory portion(s) located farther from the MAI 28, current leakage of the memory 20 can be reduced without reducing overall latency of the memory 20. Current leakage of the closer memory portion(s) could be reduced to have decreased switching speeds thereby increasing latency. The latency of the closer memory portions(s) could be increased in an asymmetrical manner in the memory 20 to still be less than or equal to the latency of the farther memory portion(s) thereby not increasing the overall latency of the memory 20. Techniques to increase latency of the memory cell transistors in the closer memory portion(s) can reduce current leakage in the closer memory portion(s) thereby lowering total current leakage of the memory 20. In this regard, asymmetrically-arranged memory may provide reduced power consumption due to reduced current leakage of the closer memory portions without increasing the overall latency of the memory.

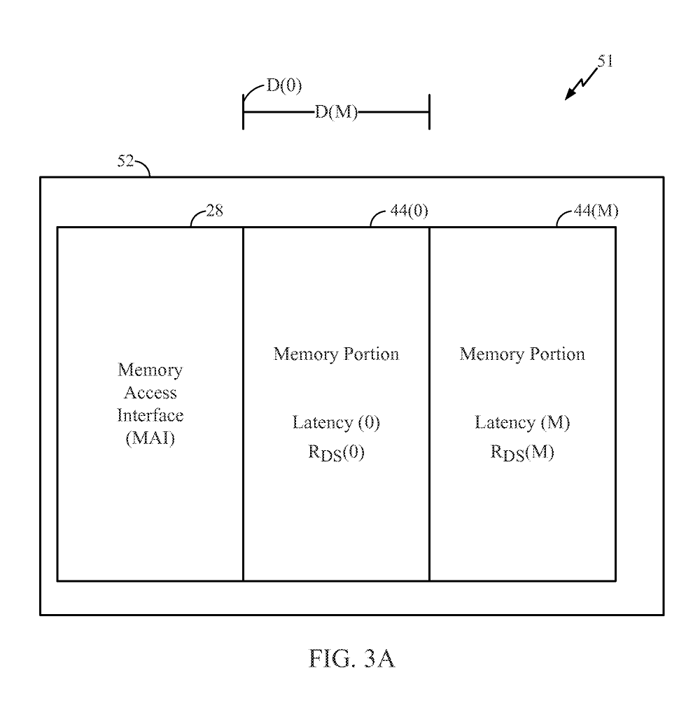

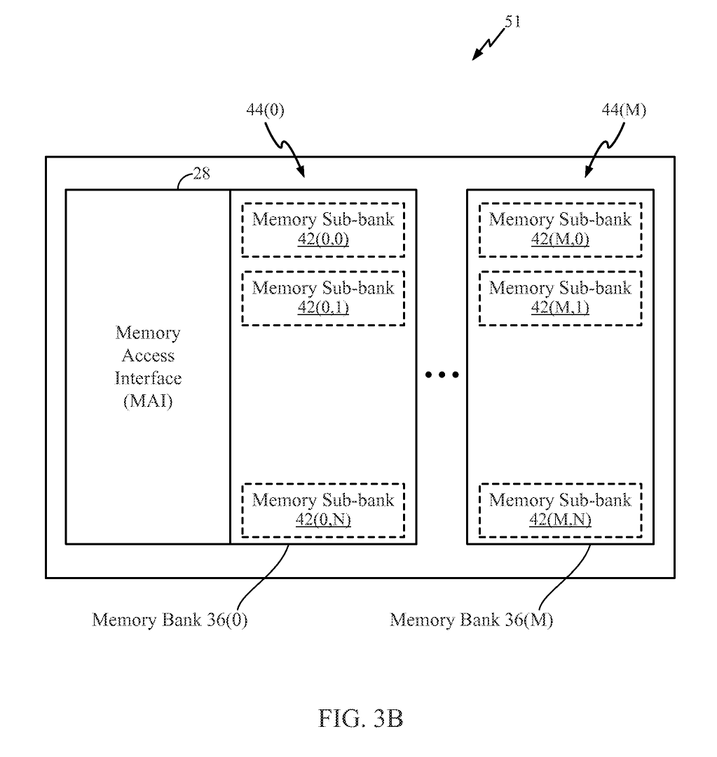

In this regard, FIG. 3A provides an exemplary embodiment of an asymmetrically-arranged memory 51 (as opposed to a symmetrically-arranged memory) that may be used as the memory 20 in the memory system 16 of FIG. 2, as a non-limiting example. As used herein, “asymmetric” or “asymmetrically-arranged memory” contains two or more memory portions, wherein at least one of the memory portions has different internal latency characteristics from the other memory portion(s). For example, a memory portion(s) located closer to a MAI can be altered to increase its internal latency characteristics due to the latency margin with respect to the memory portion(s) located farther away from the MAI. As a result, the current leakage of the closer memory portion(s), and thus the total current leakage of the memory arrangement, is reduced without increasing the overall memory access time of the memory arrangement.

A “symmetric” or “symmetrically-arranged” memory contains two or more memory portions which have the same or substantially the same internal latency characteristics. The internal latency characteristics of a memory portion are the latency characteristics that are independent of the distance of the memory portion from a MAI. Only by these memory portions being located different distances away from the MAI do memory accesses to these memory portions encounter different memory access latencies. “Internal latency” of a memory portion is the latency caused by the internal latency characteristics of the memory portion.

“Memory access latency” and/or “memory access time” of a memory portion is the latency (i.e. time) for accessing a memory portion though a MAI, which comprises internal latency of the MAI, latency (as a non-limiting example, line delays) due to the distance of the memory portion from the MAI, and internal latency of the memory portion.

With reference back to FIG. 3A, memory 51 comprises a memory access interface (MAI) 28 interfaced to a plurality of memory portions 44(0), 44(M) located on a semiconductor die 52. As will be discussed in more detail below, memory portion 44(0) has been modified to have increased internal latency compared to memory portion 44(M). As a result, the current leakage of the memory portion 11(0) is reduced thereby lowering the overall current leakage of memory 51. Though memory portion 44(0) has an increased internal latency characteristic, the memory access latency for accessing memory portion 44(M) from the MAI 28 is greater than or equal to memory access latency for accessing memory 44(0) from the MAI 28. In this regard, the memory portions 44(0), 440(M) are asymmetrically-arranged. In this manner, power consumption of memory 51 is reduced without increasing the latency of memory 51.

Accordingly, in one embodiment memory portion 44(0) has been modified to have an internal latency characteristic greater than the internal latency characteristic of memory portion 44(M) by a first latency differential threshold. In other words, due to the modifications to increase the internal latency of memory portion 44(0), memory portion 44(0) has an increased internal latency compared to memory portion 44(M) by at least the first latency differential threshold. Further due to these modifications, the current leakage of memory portion 44(M) is greater than the current leakage of memory portion 14(0).

There are various methods of increasing internal latency of a memory portion(s) (as a non-limiting example, memory portion 44(0)) to lower current leakage. For example, a transistor characteristic(s) of memory cell transistors of a memory portion(s) may be modified to tradeoff increased internal latency for reduced current leakage. In this regard, TABLE 1 below illustrates various transistor characteristics, which may be modified to affect the current leakage and internal latency of the memory portion(s). TABLE 1 illustrates effects of modifying memory cell transistor channel length (L), memory cell transistor channel width (W), and memory cell transistor threshold voltage (Vt). In addition, TABLE 1 illustrates effects of selecting among HVt, NVt, or LVt memory cell transistors to provide the memory portion(s). TABLE 1 also illustrates the effects of biasing the body (B) terminal of the memory cell transistors. Table 1 illustrates various effects of modifying the above-mentioned characteristics, including: whether the modification increases (+) or decreases (−) drain-source conductance (G_{DS}) of the induced channels of the memory cell transistors of the memory portion(s); whether the modification increases (+) or decreases (−) drain-source resistance (R_{DS}) of the induced channels of the memory cell transistors of the memory portion(s); whether the modification increases (+) or decreases (−) current leakage of the memory portion(s); and whether the modification increases (+) or decreases (−) internal latency of the memory portion(s).

TABLE 1
Exemplary Effects of Modifying Memory
Cell Transistor Characteristics

| | | Effect of Modification | | | |
|---|---|---|---|---|---|
| | | | | memory | internal |
| Transistor | | | | current | latency |
| characteristic | Modification | G_{DS} | R_{DS} | leakage | of memory |
| channel | shorter length | + | − | + | − |
| length (L) | longer length | − | + | − | + |
| channel | shorter width | − | + | − | + |
| width (W) | longer width | + | − | + | − |
| threshold | higher | − | + | − | + |
| voltage (Vt) | lower | + | − | + | − |
| HVt, NVt, | HVt | − | + | − | + |
| LVt | NVt | nominal | nominal | nominal | nominal |
| | LVt | + | − | + | − |
| Bias | Set V_{B} < V_{S} | − | + | − | + |
| | (increases Vt) | | | | |
| | V_{B} = V_{S} | nominal | nominal | nominal | nominal |
| | Set V_{B} > V_{S} | + | − | + | − |
| | (decreases Vt) | | | | |

As shown in TABLE 1 above, various transistor characteristics may be modified to provide an increased internal latency and reduced current leakage for first memory portion 44(0). In this regard, memory cell transistors of first memory portion 44(0) may have a greater channel length (L), a reduced channel width (W), and/or a higher threshold voltage (Vt) than memory cell transistors of the second memory portion 44(M). As illustrated by TABLE 1, each of these modifications increases (+) the drain-source resistance (R_{DS}) of the induced channels of the memory cell transistors of the first memory portion 44(0). In this regard, another characterization of memory 51 is that the drain-source resistance (R_{DS}) of the induced channels of the memory cell transistors of the first memory portion 44(0) is greater than the drain-source resistance (R_{DS}) of the induced channels of the memory cell transistors of the second memory portion 44(M). With continuing reference to FIG. 3A, in one embodiment, each memory portion 44 comprises at least one memory bank 36 (FIG. 2). However, memory portions 44 do not have to be memory banks 36. Sub-banks 42 of memory banks 36 may also be asymmetrically arranged. In this regard, FIG. 3B shows a memory 51 comprising memory banks 36 and memory sub-banks 42. In one embodiment, each memory portion 44(0) through 44(M) in FIG. 3A may comprise one or more memory sub-banks 42. As a non-limiting example, if each memory hank 36 has a same number of memory sub-banks N, memory portion 44(0) may comprise memory sub-hank 42(0,0), memory portion 44(1) may comprise memory sub-bank 42(0,1), . . . , memory portion 44(N) may comprise memory sub-bank 42(0,N), . . . , memory portion (M(N-1)) may comprise memory sub-bank 42(M,0), memory portion (M(N-1)+1) may comprise memory sub-bank 42(M,1), . . . , and memory portion (MN) may comprise memory sub-hank 42(M,N). However, each bank 36 may also have a same or different number of memory sub-banks as other memory banks 36 of the memory 51.

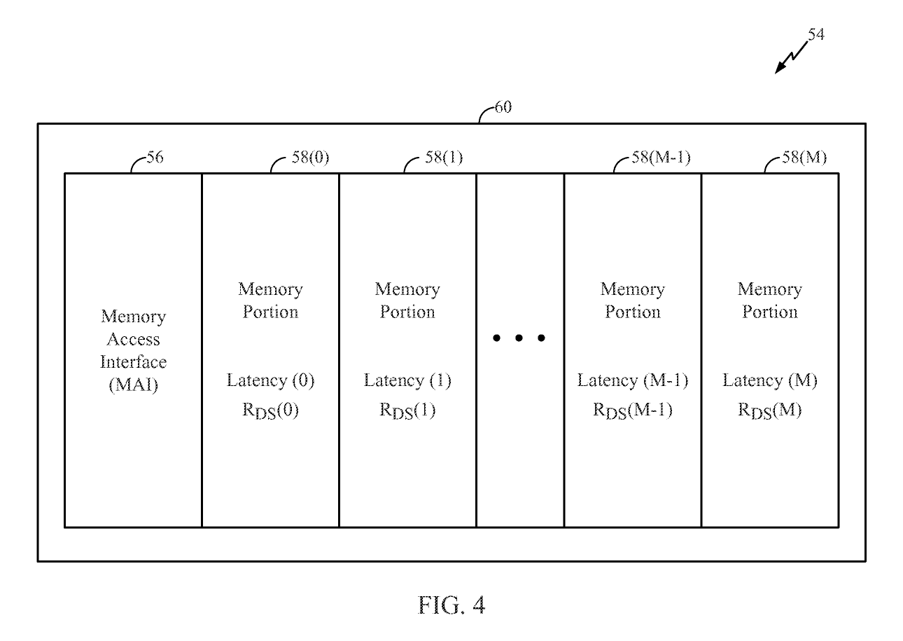

Referring now to FIG. 4, an asymmetrically-arranged memory may have two, three, four, or more memory portions. In this regard, FIG. 4 depicts an embodiment of an asymmetrically-arranged memory 54 comprising a memory access interface (MAI) 56 and a plurality of memory portions 58 (0 through M) located on a semiconductor die 60. The memory 54 provides reduced memory access latency and reduced power consumption. The memory 54 may be used as the memory 20 in the memory system 16 of FIG. 2, as a non-limiting example.

FIG. 4 illustrates a series of memory portions 58(0) through 58(M) where each preceding memory portion 58 is located closer to the memory access interface (MAI) 56 than each following memory portion 58. As a non-limiting example, a memory portion 58(0) is located closer to the MAI 56 than memory portions 58(1) and 58(M). Accordingly, the memory portion 58(0) has a latency margin compared to both the memory portion 58(1) and the memory portion 58(M). As a result, the memory portion 58(0) may be modified to have less current leakage than both memory portion 58(1) and memory portion 58(M).

In one embodiment, at least one memory portion 58 among memory portions 58(0) through 58(M-1) has been modified to have less current leakage than memory portion 58(M). In this embodiment, the at least one memory portion 58 among memory portions 58(0) through 58(M-1) may also have a greater internal latency than the memory portion 58(M), while not having a memory access latency greater than the worst-case memory access latency for any of the memory portions 58(0-M) for accessing the memory portion 58(M). In this manner, power consumption of the memory 54 is reduced without increasing the memory access latency of memory 54.

With continuing reference to FIG. 4, in another embodiment, an asymmetrically-arranged memory having three or more memory portions may have at least one memory portion 58(1) having a lesser current leakage than at least one farther memory portion 58(M) farther from the MAI 56 but a greater current leakage than at least one closer memory portion 58(0) closer to the MAI 56. In this embodiment, the at least one memory portion 58(1) may also have a greater internal latency than at least one farther memory portion 58(M) farther from the MAI 56, while not increasing the memory access time of the at least one memory portion 58(1) greater than the worst-case latency for the memory portion 58(M). The at least one memory portion 58(1) may also have a lesser internal latency than at least one closer memory portion 58(0) closer to the MAI 56. In this manner, power consumption of the memory 54 is reduced without increasing the memory access latency of memory 54.

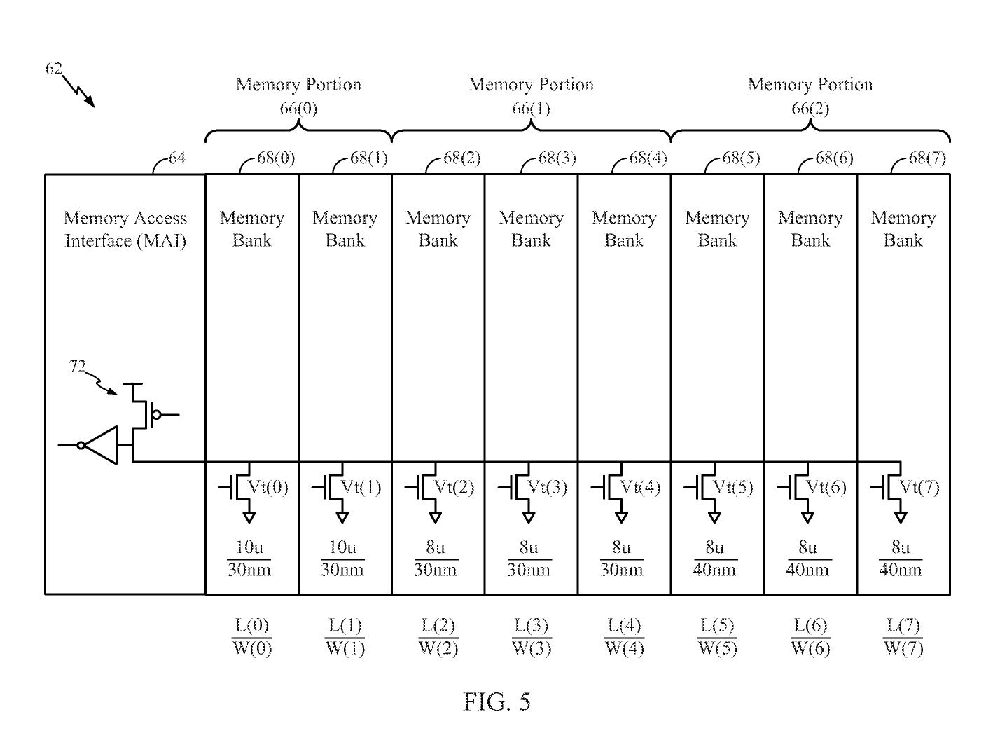

FIG. 5 provides another exemplary embodiment of an asymmetrically-arranged memory 54. In this regard, FIG. 5 provides a memory 62 having reduced memory access latency and reduced power consumption. The memory 62 is comprised of a memory access interface (MAI) 64 and a plurality of memory portions 66(0), 66(1), and 66(2). The memory portion 66(0) is comprised of memory banks 68(0) and 68(1). The memory portion 66(1) is comprised of memory banks 68(2), 68(3) and 68(4). The memory portion 66(2) is comprised of memory banks 68(5), 68(6), and 68(7). In one embodiment, memory cell transistors of the memory portion 66(0) have a channel length of 10 u and a channel width of 30 nanometers (nm). Memory cell transistors of the memory portion 66(1) have a channel length of 8 u and a channel width of 30 nanometers (nm). Memory cell transistors of the memory portion 66(2) have a channel length of 8 u and a channel width of 40 nanometers (nm).

In this embodiment, the transistors of memory portions 66(0), 66(1), and 66(2) may have a same threshold voltage (Vt). However, in another embodiment, the transistors of memory portions 66(0), 66(1), and 66(2) may also be provided having different threshold voltages (Vt) in accordance with FIG. 3A and/or FIG. 4. In this regard, the memory portion 66(0) may provide memory threshold voltages Vt(0) and Vt(1) which are higher than memory threshold voltages Vt(2), Vt(3), and Vt(4) and/or memory threshold voltages Vt(5), Vt(6), and Vt(7). In a further embodiment, memory portion 66(1) may provide threshold voltages Vt(2), Vt(3) and Vt(4) which are higher than memory threshold voltages Vt(5), Vt(6), and Vt(7).

As illustrated in FIG. 5, the memory access interface (MAI) 64 may include a global bit line driver 72. Because herein discussed apparatuses and methods provide reduced load and reduced power consumption of memory banks 68(0) through 68(7) by using asymmetric memory portions 66(0), 66(1), 66(2), the global bit line driver 72 does not need to be as large as a global bit line driver 72 for a symmetric bank memory in order to achieve the same performance and memory latency. A smaller global bit line driver consumes less power than a larger global bit line driver. As a result, a further reduced power memory 62 may be provided by reducing the size of the global bit line driver 72 in accordance with the reduced load provided by the asymmetric memory banks 68(0) through 68(7).

Additional components of memory 62 may also be modified to provide a further reduced power consumption memory 62, based on the reduced load and power consumption of the memory banks 68(0) through 68(7) realized in accordance with the herein discussed apparatuses and methods. Because herein discussed apparatuses and methods provide reduced load and reduced power consumption of memory banks 68(0) through 68(7) by using asymmetric memory portions, local input drivers for each of the memory banks 68(0) through 68(7) do not need to be as large as local input drivers provided for symmetric memory banks. Smaller local input drivers consume less power than larger local input drivers. In this regard, local input drivers for each memory bank 68(0), 68(1) may be made smaller than local input drivers for each memory bank 68(2), 68(3), 68(4), 68(5), 68(6), and 68(7). Similarly, local input drivers for each memory bank 68(2), 68(3), and 68(4) may be made smaller than local input drivers for each memory bank 68(5), 68(6), and 68(7). In this manner, the memory 62 may be made to provide further reduced power consumption.

In addition, because herein discussed apparatuses and methods provide reduced load and reduced power consumption of the memory banks 68(0) through 68(7) by using asymmetric memory portions, local memory address decoders for each memory bank 68(0) through 68(7) do not need to be as large as local memory address decoders provided for symmetric memory banks. Smaller memory address decoders consume less power than larger memory address decoders. In this regard, local memory address decoders for each memory bank 68(0), 68(1) may be made smaller than local memory address decoders for each memory bank 68(2), 68(3), 68(4), 68(5), 68(6), and 68(7). Similarly, local memory address decoders for each memory bank 68(2), 68(3), and 68(4) may be made smaller than local memory address decoders for each memory bank 68(5), 68(6), and 68(7). In this manner, the memory 62 may be made to provide even further reduced power consumption. The memory 62 may be used as the memory 20 in the memory system 16 of FIG. 2, as a non-limiting example.

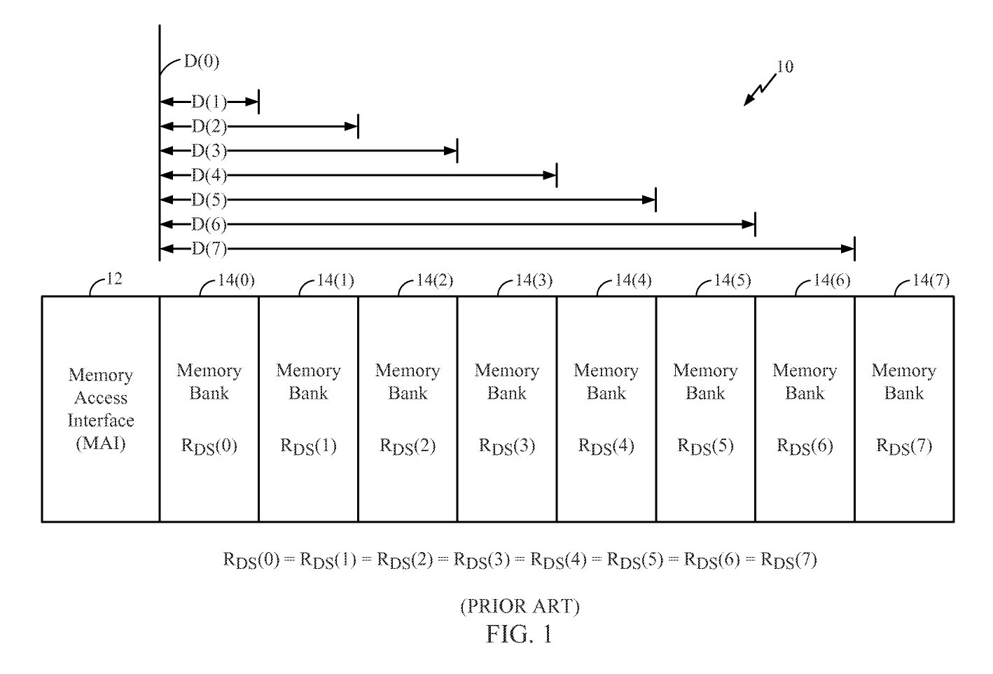

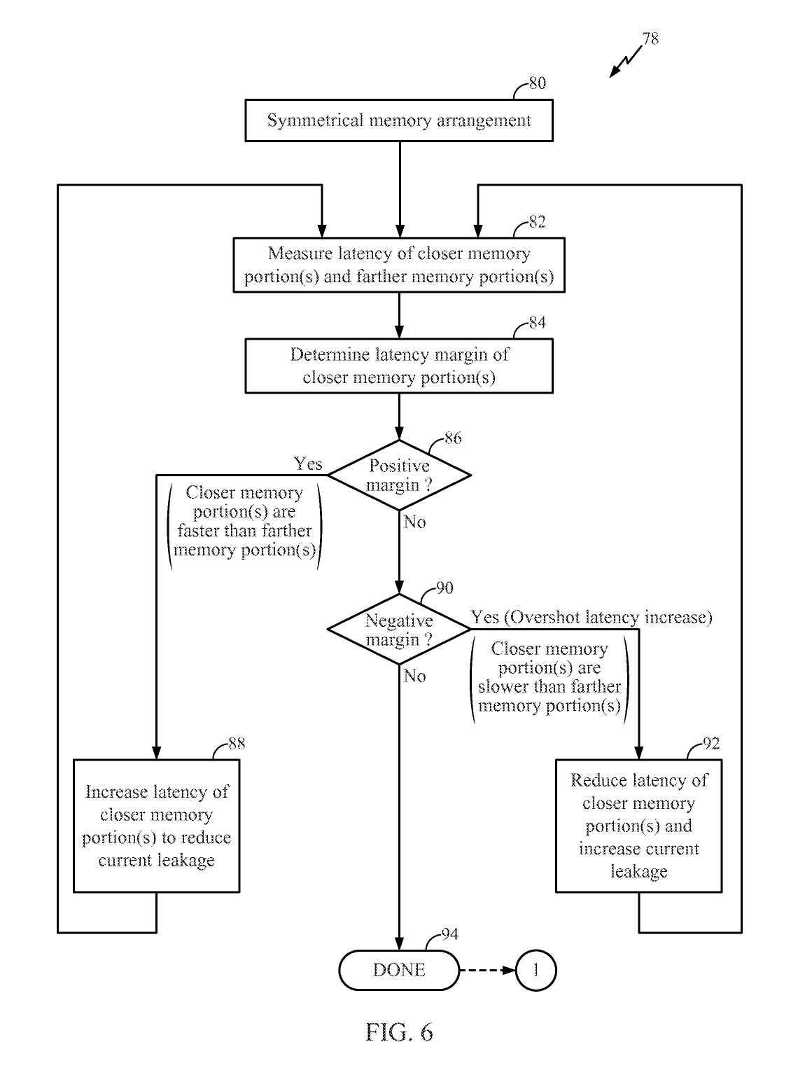

FIG. 6 illustrates a flowchart for a method 78 of designing an asymmetric memory 20, 51, 54, 62 of FIGS. 2, 3A, 3B, 4, and/or 5 which optimizes current leakage of a closer memory portion(s) 44(0) (FIGS. 3A and 3B) (as further non-limiting examples, closer memory portion(s) 58(0)-58(M-1) in FIG. 4 and/or closer memory portion(s) 66(0) and 66(1) in FIG. 5) based on a determined latency margin based on memory access latency of a farther memory portion(s) 44(M) (FIGS. 3A and 3B) (as further non-limiting examples, farther memory portion(s) 58(M) in FIG. 4 and/or farther memory portion(s) 66(2) in FIG. 5). A symmetrical memory arrangement (as a non-limiting example, the memory 10 of FIG. 1) is first provided (block 80). The symmetrical memory arrangement may first be modified to provide lower-threshold voltage (lower-Vt) memory cell transistors for all memory portions 44 such that the farther memory portion(s) 44(M) provide an acceptable latency according to design specification requirements for the memory 20 (block 80). The latency of the closer memory portion(s) 44(0) and the latency of the farther memory portion(s) 44(M) are measured (block 82). A farther memory portion 44(M) may be a memory portion located farthest from the MAI 28, as a non-limiting example. Based on the measured latencies of the closer memory portion(s) 44(0) and the farther memory portion(s) 44(M), a latency margin of the closer memory portion(s) 44(0) is determined (block 84). If the closer memory portion(s) 44(0) have a positive latency margin (block 86, YES) in excess of a positive latency margin threshold, then the closer memory portion(s) 44(0) may be modified to increase latency and reduce current leakage of the closer memory portion(s) 44(0) (block 88). In this regard, a transistor characteristic(s) in one or more memory sub-bank(s) 42 and/or bank(s) 36 of the closer memory portion(s) 44(0) may be modified to increase latency and reduce current leakage of the closer memory portion(s) 44(0) (block 88). Thereafter, the latency of the closer memory portion(s) 44(0) and the latency of the farther memory portion(s) 44(M) are again measured (block 82) and the design proceeds further as herein discussed.

If the closer memory portion(s) 44(0) has a negative latency margin which exceeds a negative latency margin threshold (block 90, YES) (which may happen if a latency increase of the closer memory portion(s) 44(0) was overshot (i.e. increased too much) in a previous block), then the closer memory portion(s) 44(0) may be modified to reduce latency and increase current leakage of the closer memory portion(s) 44(0) (block 92). In this regard a transistor characteristic(s) in a memory sub-banks) 42 and/or memory bank(s) 36 of the closer memory portion(s) 44(0) may be modified to reduce latency and increase current leakage of the closer memory portions) 44(0) (block 92).

If the determined latency margin of the closer memory portion(s) 44(0) is less than the positive latency margin threshold and greater than the negative latency margin threshold, then the method continues to block 94.

At this point, an asymmetric memory 20 (as further non-limiting examples 51, 54, 62) has been designed which provides reduced current leakage and reduced latency (i.e. reduced memory latency and increased memory speed) than the symmetric memory (from block 80). This asymmetric memory 20, 51, 54, 62 contains asymmetric memory portions 14, 58, 66 (as non-limiting examples, asymmetric memory sub-banks 42 and/or asymmetric memory banks 36) as herein discussed regarding FIGS. 2, 3A, 3B, 4, and/or 5. Accordingly, at this point the design may be considered done (block 94).

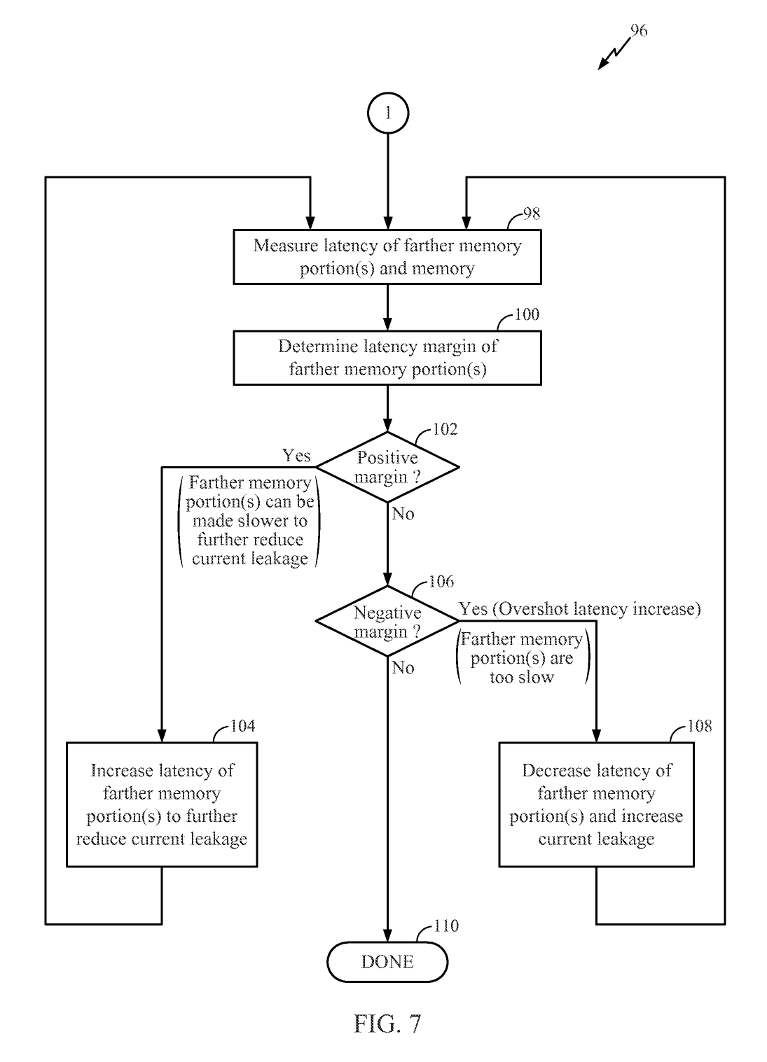

In some embodiments, such as FIG. 5, a global bit line driver 72 is provided. As a result of modifying the closer memory portion(s) 44(0) to have reduced current leakage (from performing the method of FIG. 6), the closer memory portion(s) 44(0) now provide a reduced load on the farther memory portion(s) 44(M) than experienced by the farther memory portion(s) in the symmetric memory arrangement. Because there is reduced load on the farther memory portion(s) 44(M), the farther memory portion(s) 44(M) will now have reduced latency (i.e. operate faster) compared to the farther memory portion(s) operated in the symmetric memory arrangement. As a result, the farther memory portion(s) 44(M) now has a positive latency margin. A positive latency margin occurs for a memory portion 44 of a memory 20 (as non-limiting examples, one or more memory sub-banks and/or one or more memory banks) when the memory portion has a lower latency than required (i.e., the memory portion is faster than it needs to be) to meet specified memory timing requirements for the memory 20. By contrast, negative latency margin occurs for a memory portion 44 of a memory 20 when the memory portion 44 has too much latency (i.e., the memory portion 44 is slower than it needs to be) to meet specified memory timing requirements for the memory 20. Realizing that at block 94 the farther memory portion(s) 44(M) has a positive latency margin, FIG. 7 provides a method 96 for further reducing the current leakage of the farther memory portion(s) 44(M) in light of a positive latency margin existing for the farther memory portion(s) 44(M).

In this regard, referring now to FIG. 7, the asymmetric memory 20 (as further non-limiting examples, 51, 54, 62) resulting from block 94 of FIG. 6 is provided (circle 1). The latency of the farther memory portion(s) 44(M) and the overall latency of memory 20 is measured (block 98). Based on the measured latency of the farther memory portion(s) 44(M) and the memory 20, latency margin of the farther memory portion(s) 44(M) is determined (block 100). If the farther memory portion(s) 44(M) has a positive latency margin (block 102, YES) in excess of the positive latency margin threshold, then the farther memory portion(s) 44(M) may be modified to increase latency and reduce current leakage of the farther memory portion(s) 44(M) (block 104). In this regard, a transistor characteristic(s) in a memory sub-bank(s) 42 and/or bank(s) 36 of the farther memory portions(s) 44(M) may be modified to reduce current leakage of the farther memory portion(s) 44(M) (block 104). Thereafter, the latency of the farther memory portion(s) 44(M) and the overall latency of memory 20 is measured (block 98) and the design proceeds further as herein discussed.

If the farther memory portion(s) 44(M) has a negative latency margin which exceeds the negative latency margin threshold (block 106, YES) (which may happen if a latency increase of the farther memory portion(s) 44(M) was overshot (i.e. modified too much) in a previous block), then the farther memory portion(s) 44(M) may be modified to reduce latency and increase current leakage of the farther memory portion(s) 44(M) (block 108). In this regard, a transistor characteristic(s) in a memory sub-bank(s) 42 and/or bank(s) 36 of the farther memory portion(s) 44(M) may be modified to reduce latency of the farther memory portion(s) 44(M) (block 108).

If the determined latency margin of the farther memory portion(s) 44(M) is less than the positive latency margin threshold and greater than the negative latency margin threshold, then the method ends (block 110). At this point, an asymmetric memory 20, 51, 54, 62 has been designed which provides reduced current leakage compared to the asymmetric memory of block 94 of FIG. 6. This asymmetric memory 20 (as further non-limiting examples asymmetric memory 54, 62) contains asymmetric memory portions (as non-limiting examples, asymmetric memory sub-banks 42 and/or asymmetric memory banks 36) as herein discussed regarding FIGS. 2, 3A, 3B, 4, and/or 5. Accordingly, at this point the design may be considered done (block 110).

Alternatively, power consumption of memory 20, 51, 54, 62 may be reduced even further by reducing the size of the global bit line driver 72, by reducing the size of local input drivers for each of the memory portions 44, and/or by reducing the size of memory address decoders for each of the memory portions 44, as herein also discussed.

Herein disclosed embodiments discuss reducing current leakage. Reducing current leakage may comprise reducing drain-source current (I_{DS}) of memory cell transistors of the memory while the gate-source voltage (V_{GS}) is lower than the threshold voltage (Vt) of the memory cell transistors of the memory. However, reducing current leakage may also comprise reducing other current leakage of the memory cell transistors of the memory. As a non-limiting example, reducing current leakage may also comprise reducing gate-to-source current leakage through an oxide layer of memory cell transistors of the memory.

The asymmetrically-arranged memories having reduced current leakage and/or latency, and related systems and methods according to embodiments disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

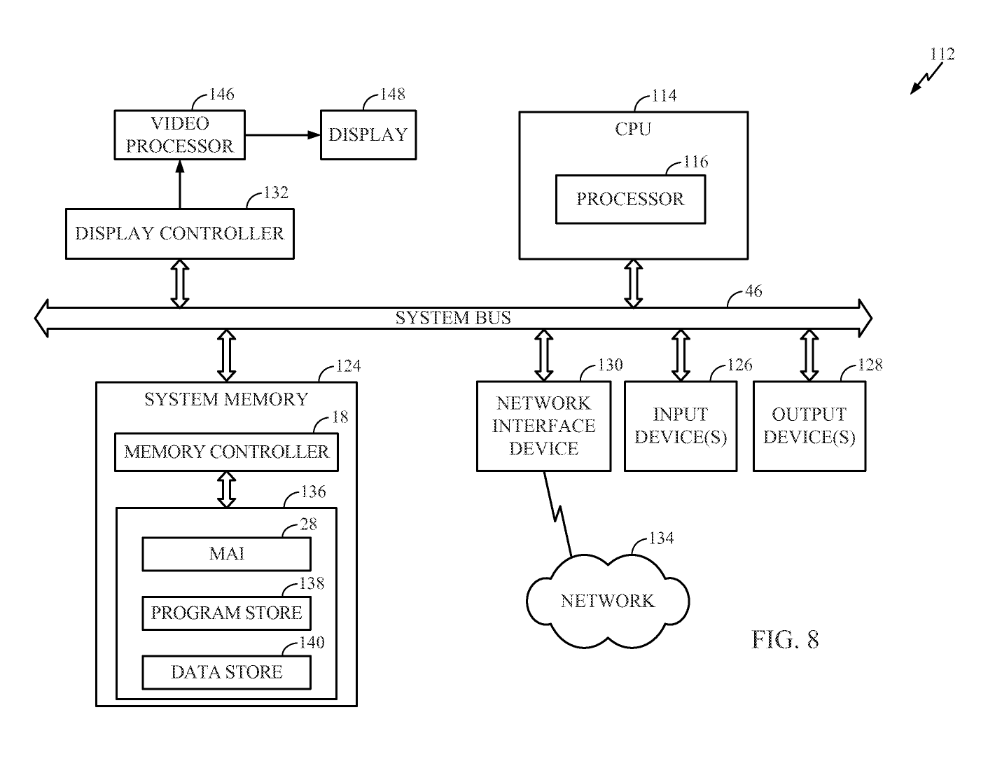

In this regard, FIG. 8 illustrates an example of a processor-based system 112 that can employ the asymmetric memories 20, 51, 54, 62 illustrated in FIGS. 2, 3A, 3B, 4, and/or 5 or designed according to the methods 78, 96 of FIGS. 6 and 7. In this example, the processor-based system 112 includes one or more central processing units (CPUs) 114, each including one or more processors 116. The CPU(s) 114 may be a master device. The CPU(s) 114 is coupled to a system bus 46 and can intercouple master devices and slave devices included in the processor-based system 112. As is well known, the CPU(s) 114 communicates with these other devices by exchanging address, control, and data information over the system bus 46. For example, the CPU(s) 114 can communicate bus transaction requests to the memory controller 18. Although not illustrated in FIG. 8, multiple system buses 46 could be provided, wherein each system bus 46 constitutes a different fabric.

Other master and slave devices can be connected to the system bus 46. As illustrated in FIG. 8, these devices can include a system memory 124, one or more input devices 126, one or more output devices 128, one or more network interface devices 130, and one or more display controllers 132, as examples. The input device(s) 126 can include any type of input device, including but not limited to input keys, switches, voice processors, etc. The output device(s) 128 can include any type of output device, including but not limited to audio, video, other visual indicators, etc. The network interface device(s) 130 can be any devices configured to allow exchange of data to and from a network 134. The network 134 can be any type of network, including but not limited to a wired or wireless network, private or public network, a local area network (LAN), a wide local area network (WLAN), and the Internet. The network interface device(s) 130 can be configured to support any type of communication protocol desired. Memory 136 of the system memory 124 may comprise one or more memory chips 20 (FIG. 2) each comprising one or more memory portions 44, one or more memory sub-banks 42, and/or one or more memory banks 36. The memory 136 of system memory 124 may contain a program store 160 and/or a data store 162.

The CPU(s) 114 may also be configured to access the display controller(s) 132 over the system bus 46 to control information sent to one or more displays 148. The display controller(s) 132 sends information to the display(s) 148 to be displayed via one or more video processors 146, which processes the information to be displayed into a format suitable for the display(s) 148. The display(s) 148 can include any type of display, including but not limited to a cathode ray tube (CRT), a liquid crystal display (LCD), a light emitting diode (LED) display, a plasma display, a two dimensional (2-D) display, a three dimensional (3-D) display, a touch-screen display, etc.

The CPU(s) 114 and the display controller(s) 132 may act as master devices to make memory access requests to one or more memory access interfaces (MAIs) 28 of memory chips 20 of memories 136 over the system bus 46. Different threads within the CPU(s) 114 and the display controller(s) 132 may make requests to access memory to memory controller 18 which in turn accesses memory through the one or more memory access interfaces (MAN) 28 of memory chips 20 of the memory 136. Any memory in the system 112, including memory 136, may be provided as asymmetric memory according to the apparatuses and methods disclosed herein.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The memories, memory banks, memory sub-banks, memory access interfaces (MAIs), memory controllers, buses, master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a processor, a digital signal processor (DSP), an Application Specific Integrated Circuit (ASIC), an Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A memory, comprising:
a memory access interface;
at least one first memory portion accessible by the memory access interface, the at least one first memory portion having a first latency and a first current leakage; and
at least one second memory portion accessible by the memory access interface, the at least one second memory portion having a second latency greater than or equal to the first latency and a second current leakage greater than the first current leakage.

2. The memory of claim 1, wherein the at least one first memory portion is comprised of at least one first memory sub-bank and wherein the at least one second memory portion is comprised of at least one second memory sub-bank.

3. The memory of claim 1, wherein the at least one first memory portion is comprised of at least one first memory bank and wherein the at least one second memory portion is comprised of at least one second memory bank.

4. The memory of claim 1, wherein the at least one first memory portion is located a first distance from the memory access interface and the at least one second memory portion is located a second distance greater than the first distance from the memory access interface.

5. The memory of claim 1, wherein an internal latency of the first memory portion is greater than an internal latency of the second memory portion by a first latency differential threshold and the second current leakage is greater than the first current leakage by a first current leakage differential threshold.

6. The memory of claim 1, wherein
the at least one first memory portion comprises first memory cell transistors having a first channel length, a first channel width, and a first threshold voltage (Vt),
the at least one second memory portion comprises second memory cell transistors having a second channel length, a second channel width, and a second threshold voltage (Vt), and
wherein at least one of:
the first channel length is longer than the second channel length,
the first channel width is shorter than the second channel width, and
the first threshold voltage (Vt) is higher than the second threshold voltage (Vt).

7. The memory of claim 1,
wherein the at least one first memory portion comprises first memory cell transistors and the at least one second memory portion comprises second memory cell transistors,
and wherein at least one of:
the first memory cell transistors are comprised of at least one of nominal threshold voltage (NVt) transistors and higher voltage threshold (HVt) transistors, and the second memory cell transistors are comprised of lower voltage threshold (LVt) transistors, and
the first memory cell transistors are comprised of higher voltage threshold (HVt) transistors, and the second memory cell transistors are comprised of at least one of nominal threshold voltage (NVt) transistors and lower voltage threshold (LVt) transistors.

8. The memory of claim 1, wherein a first memory access from the memory access interface to the at least one first memory portion is less than a second memory access from the memory access interface to the at least one second memory portion.

9. The memory of claim 1, wherein the at least one first memory portion comprises at least one first memory cell transistor having a first substrate (B) bias voltage and the at least one second memory portion comprises at least one second memory cell transistor having has a second substrate (B) bias voltage higher than the first substrate (B) bias voltage.

10. The memory of claim 1, the memory further comprising at least one third memory portion accessible by the memory access interface, the at least one third memory portion having a third latency greater than or equal to the first latency and lesser than or equal to the second latency and a third current leakage greater than the first current leakage and lesser than the second current leakage.

11. The memory of claim 10, wherein the at least one third memory portion is farther in distance from the memory access interface than the at least one first memory portion and closer in distance to the memory access interface than the at least one second memory portion.

12. The memory of claim 1 integrated into a semiconductor die.

13. The memory of claim 1, the memory disposed in a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player, into which the memory is integrated.

14. A memory, comprising:
a memory access interface means;
at least one first memory portion means accessible by the memory access interface means, the at least one first memory portion means having a first latency and a first current leakage; and
at least one second memory portion means accessible by the memory access interface means, the at least one second memory portion means having a second latency greater than or equal to the first latency and a second current leakage greater than the first current leakage.

15. A memory system, comprising:
a memory, comprising:
a memory access interface;
at least one first memory portion accessible by the memory access interface, the at least one first men or portion having a first latency and a first current leakage; and
at least one second memory portion accessible by the memory access interface, the at least one second portion having a second latency greater than or equal to the first latency and a second current leakage greater than the first current leakage; and
a memory controller configured to access the memory through access to the memory access interface.

16. The memory system of claim 15,
wherein the at least one first memory portion comprises first memory cell transistors and the at least one second memos v portion comprises second memory cell transistors, and
wherein the first memory cell transistors have a first channel length, a first channel width, and a first threshold voltage (Vt),
wherein the second memory cell transistors have a second channel length, a second channel width, and a second threshold voltage (Vt), and
wherein at least one of:
the first channel length is longer than the second channel length,
the first channel width is shorter than the second channel width, and
the first threshold voltage (Vt) is higher than the second threshold voltage (Vt).

17. A method of designing a memory, comprising:
providing a memory arrangement comprising:
a memory access interface; and
symmetric memory portions;
measuring a first latency of at least one farther memory portion from the memory access interface;
measuring a second latency of at least one closer memory portion to the memory access interface;
determining latency margin of the at least one closer memory portion; and
in response to determining the at least one closer memory portion has positive latency margin, increasing the latency in the at least one closer memory portion to reduce current leakage of the at least one closer memory portion.

18. The method of claim 17, further comprising, in response to the overall load of the memory being reduced by increasing the latency in the at least one closer memory portion to reduce current leakage of the at least one closer memory portion:
remeasuring the first latency of the at least one farther memory portion;
measuring an overall latency of the memory;
determining latency margin of the at least one farther memory portion;
in response to determining the at least one farther memory portion has positive latency margin, increasing the latency in the at least one farther memory portion to reduce current leakage of the at least one farther memory portion.

19. The memory of claim 17, further comprising reducing a size of a global bit line driver driving at least one first input of the at least one closer memory portion and at least one second input of the at least one farther memory portion.

20. The method of claim 17, further comprising:
in response to determining the at least one closer memory portion has negative latency margin, reducing the latency in the at least one closer memory portion and increasing current leakage of the at least one closer memory portion.

21. A non-transitory computer-readable medium having stored thereon computer-executable instructions to cause a processor to:
provide a memory arrangement comprising:
a memory access interface; and
symmetric memory portions;
measure a first latency of at least one farther memory portion from the memory access interface;
measure a second latency of at least one closer memory portion to the memory access interface;
determine latency margin of the at least one closer memory portion; and
in response to determining the at least one closer memory portion has positive latency margin, increase the latency in the at least one closer memory portion to reduce current leakage of the at least one closer memory portion.
